(19) United States
(12) Patent Application Publication
(10) Pub. No.: US 2015/0209944 A1
(43) Pub. Date: Jul. 30, 2015

(54) SOCKET WRENCH APPARATUS

(71) Applicant: Yao-Lin Cho, Taichung City (TW)

(72) Inventor: Yao-Lin Cho, Taichung City (TW)

(21) Appl. No.: 14/165,588

(22) Filed: Jan. 28, 2014

(51) Int. Cl. B25B 23/00; B25G 3/12; B25B 13/46

(52) U.S. Cl. CPC B25B 23/0007; B25B 13/46; B25G 3/12

(57) ABSTRACT

A wrench apparatus includes an elongate handle, a first working head and a second working head selectively attached to the elongate handle. Specifically, the elongate handle has a handle portion and a female end extending from the handle portion. The female end of the handle defines axially a recess. The second working head is relatively smaller in size than the first working head. Each of the first and second working head has a head portion and a shank integrally extending from the head portion. The shank has a free male end to be engaged in the recess of the female end of the handle.

### BACKGROUND OF THE INVENTION

1. Field of the Invention

The present invention relates to a wrench apparatus and more particularly to a wrench apparatus having a plurality of working heads of different sizes for interchangeably joined to the single handle portion thereof.

2. Description of the Related Art

Wrenches heretofore devised and utilized are known to consist basically of familiar, expected and obvious structural configurations, notwithstanding the myriad of designs encompassed by the crowded prior art which have been developed for the fulfillment of countless objectives and requirements.

Most wrenches are bulky and of significant weight. A standard wrench set has multiple handles, socket extensions, sockets, etc. Carrying or storing a full set of wrenches may be difficult due to its bulk and significant weight. In order to reduce the weight, the tool industry offers ratchet systems with a drive which fits several different socket extension. This allows a single handle to be used for several different configurations.

For example, as shown in FIG. 6, a ratchet wrench 900 typically includes a handle portion 91 and a ratchet head 92 integrally formed with the handle portion 91. The ratchet head 92 has a ratchet mechanism 920 therein and a rotatable generally rectangular drive 921 outwardly extending from the ratchet mechanism 920. Moreover, sockets (not shown) of different sizes are provided for interchangeably snapping onto the ratchet head 92. Each socket comprises a tubular member with internal facets for closely fitting over a nut or bolt, and a square hole in the opposite end for receiving the rectangular drive 921 on the ratchet head 92. While the ratchet wrench 900 fulfills its basic objectives and requirements, the length of the ratchet wrench 900 is limited. There are still many bulky pieces which are redundant for any particular configuration.

### SUMMARY OF THE INVENTION

In view of the foregoing disadvantages inherent in the known types of wrenches now present in the prior art, the present invention provides a new wrench apparatus which can be utilized for permitting a user to change working heads, such as ratchet heads, to suit the needs of the user.

To attain this, the present invention generally comprises a first working head, a second working head and an elongate handle. Each of the first and second working heads has a head portion and a shank integrally extending from the head portion. The shank has a free male end. On the other hand, the elongate handle has a handle portion and a female end extending from the handle portion. The female end of the elongate handle defines axially a recess for engaging the male end of the shank of the first working head such that the first working head is detachably connected to the elongate handle, Similarly, the second working head is configured to be detachably connected to the elongate handle with its female end engaged with the male end of the elongate handle. The second working head is smaller in size than the first working head to serve as an alternate to the first working head. Preferably, the head portion of each of the first and second working heads is a ratchet head having a ratchet mechanism therein and a rotatable generally rectangular drive outwardly extending from the ratchet mechanism.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a wrench apparatus in accordance with the preferred embodiment of the present invention;

FIG. 2 is a perspective view of the wrench apparatus, showing a first, larger working head is detachably joined to a handle portion;

FIG. 3 is another perspective view of the wrench apparatus, showing a second smaller working head is detachably joined to the handle portion;

FIG. 4 is a partial enlarged cross-sectional view taken along the line IV-IV in FIG. 2, showing that a shank of the first working head is engaged in the handle portion;

FIG. 5 is a view similar to FIG. 4, showing that the shank of the first working head is released and readily detachable from the handle portion; and

FIG. 6 is a prior art.

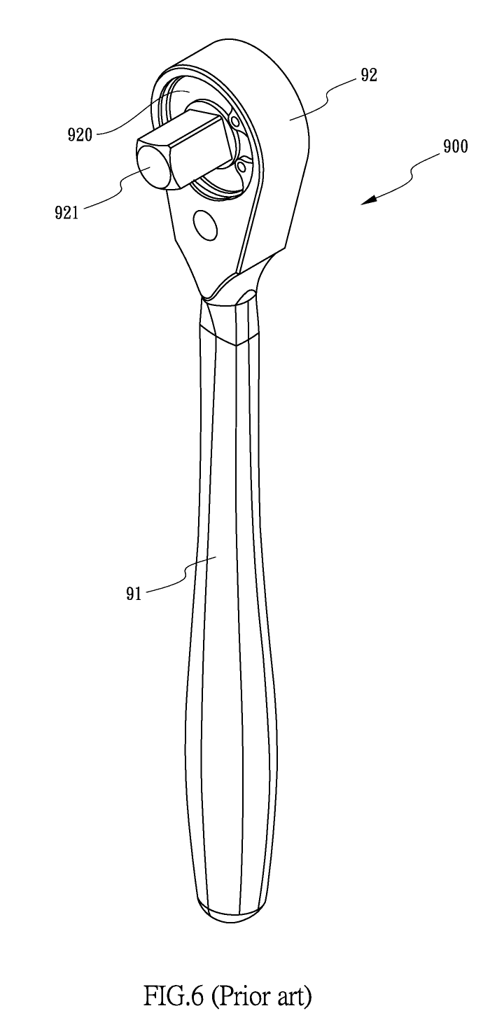

### DETAILED DESCRIPTION OF EMBODIMENTS

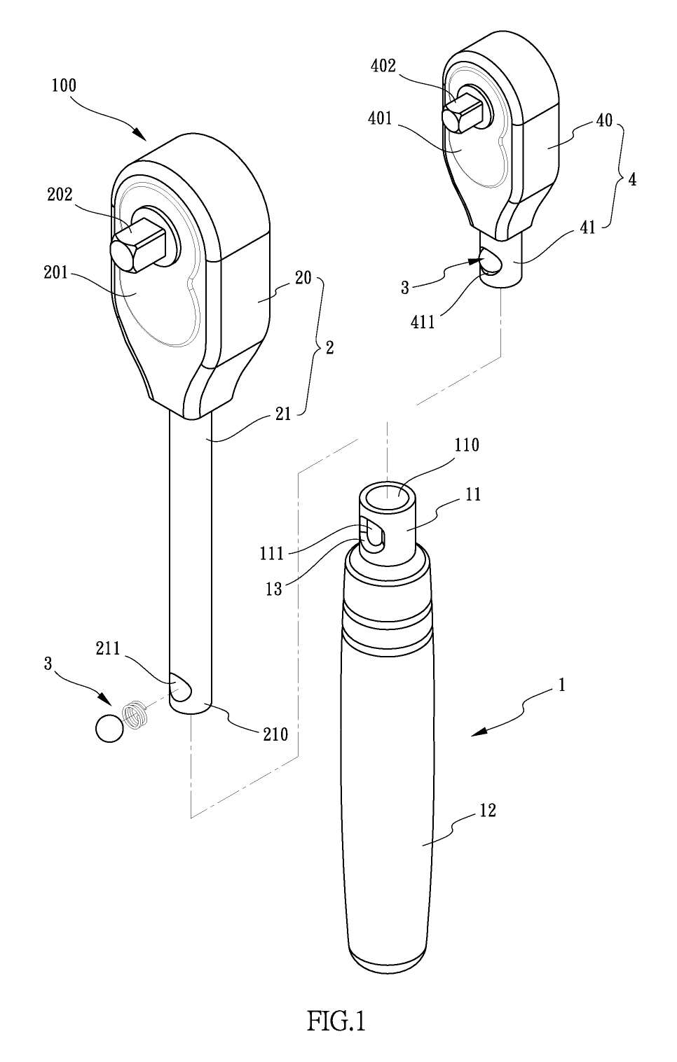

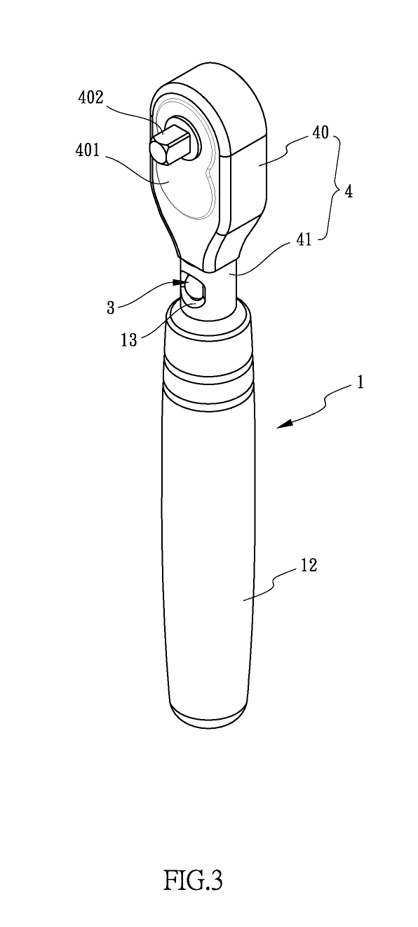

Referring now to the drawings, and particularly to FIGS. 1-5, a preferred embodiment of the wrench apparatus of the present invention is shown and generally designated by the reference numeral 100. As shown in FIG. 1, the wrench apparatus 100 generally includes a handle portion 1, a first, larger working head 2 and a second, smaller working head 4.

Specifically, the first working head 2 has a head portion 20 and a shank 21 integrally extending from the head portion 20. The shank 21 has a free male end 210. As shown, the first working head is directed to ratchet heads and selectively attached to the handle portion 1 to form a ratchet wrench. Thus, the head portion 20 of the first working head 2 includes a ratchet mechanism 201 therein and a rotatable generally rectangular drive 202 outwardly extending from the ratchet mechanism 201. Similarly, the second working head 4 has a head portion 40 and a shank 41 integrally extending from the head portion 40 with a free male end 410. The head portion 40 of the second working head 4 includes a ratchet mechanism 401 therein and a rotatable generally rectangular drive 402 outwardly extending from the ratchet mechanism 401. The second working head 4 is smaller in size than the first working head 2 to serve as an alternate to the first working head 2.

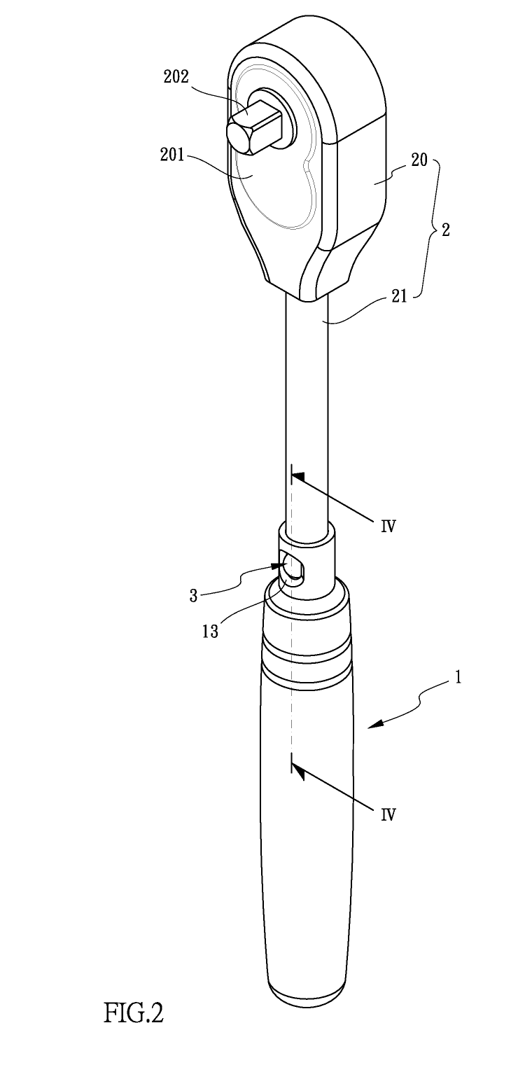

More specifically, the elongate handle 1 has a handle portion 12 and a female end 11 extending from the handle portion 12. The female end 11 defines axially a recess 110 for engaging the male end 210 of the shank 21 of the first working head 2 such that the first working head 2 may be detachably connected to the elongate handle 1, as shown in FIG. 2. Alternatively, the second working head 4 may be inserted in the recess 110 of the female end 11 of the elongate handle 1 with the shorter shank 41 for engaging the elongate handle 1.

As shown in FIG. 1, the shank 21 of the first working head 2 is longer than the head portion 20 of the first working head 2 while the shank 41 of the second working head 4 is shorter than the head portion 40 of the second working head 4. Moreover, the length of shank 41 of the second working head 4 is substantially identical to that of the female end 11 of the elongate handle 1. This ensures that the first or second working heads 2, 4 can be securely attached to the elongate handle 1.

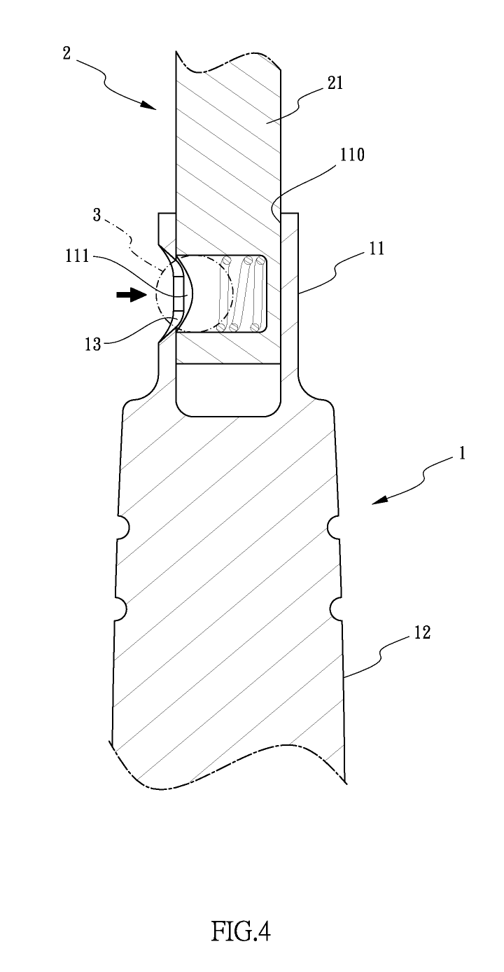

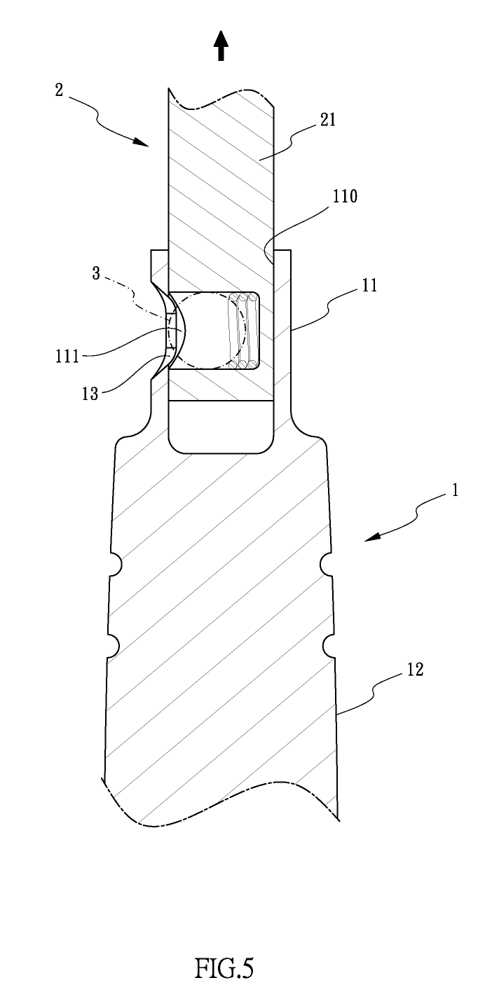

Referring again to FIG. 1, the shank 21 of the first working head 1 defines a receiving hole 211 in a side of the male end 210. A spring-loaded locking ball 3 is lodged in the receiving hole 211 in the male end 210 of the shank 21. On the other hand, the elongate handle 1 defines a detent hole 111 in a side of the female end 11 for engaging the spring-loaded locking ball 3 on the male end 210 of the shank 21. Preferably, the detent hole 111 in the female end 11 of the elongate handle 1 has an outwardly flared wall surface 13 configured corresponding to a finger pulp of a user. Thus, the user may push the spring-loaded locking ball 3 with his or her finger in a direction as indicated by the arrow shown in FIG. 4 to quickly release the shank 21 of the first working head 2 as depicted in FIG. 5. More specifically, being pushed by the finger of the user, the spring-loaded locking ball 3 will be completely retracted into the recess 110 in the female end 11 of the elongate handle 1 to permit withdrawal of the shank 21 of the first working head 2 from the elongate handle 1 in a direction indicated by the arrow shown in FIG. 5.

It is to be understood that the disclosed embodiments are illustrative in nature and the invention is not to be limited to any one or more embodiments except as set forth in the following claims.

What is claimed is:

1. A wrench apparatus comprising:
a first working head having a head portion and a shank integrally extending from the head portion; the shank having a free male end; and
an elongate handle having a handle portion and a female end extending from the handle portion; the female end defining axially a recess for engaging the male end of the shank of the first working head such that the first working head is detachably connected to the elongate handle.

2. A wrench apparatus as recited in claim 1, wherein the head portion of the first working head is a ratchet head having a ratchet mechanism therein and a rotatable generally rectangular drive outwardly extending from the ratchet mechanism.

3. A wrench apparatus as recited in claim 1, further comprising a second working head having a head portion and a shank integrally extending from the head portion so as to be detachably connected to the elongate handle, wherein the second working head is smaller in size than the first working head to serve as an alternate to the first working head.

4. A wrench apparatus as recited in claim 3, wherein the shank of the first working head is longer than the head portion of the first working head while the shank of the second working head is shorter than the head portion of the second working head.

5. A wrench apparatus as recited in claim 4, wherein the length of shank of the second working head is substantially identical to that of the female end of the elongate handle.

6. A wrench apparatus as recited in claim 1, wherein the shank of the first working head defines a receiving hole in a side of the male end; the wrench apparatus further has a spring-loaded locking ball lodged in the receiving hole in the shank; and the elongate handle defines a detent hole in a side of the female end for engaging the spring-loaded locking ball on the male end of the shank.

7. A wrench apparatus as recited in claim 6, wherein the detent hole in the female end of the elongate handle has an outwardly flared wall surface.
